(19) United States
(12) Patent Application Publication
(10) Pub. No.: US 2009/0100096 A1
(43) Pub. Date: Apr. 16, 2009

(54) Systems, Devices, and Methods for Transferring Digital Information

(75) Inventors: Andrew Erlichson, Metuchen, NJ (US); Mark Heinrich, Celebration, FL (US)

Correspondence Address: MICHAEL N. HAYNES, 1341 HUNTERSFIELD CLOSE, KESWICK, VA, 22947, US

(73) Assignee: PHANFARE, INC., Metuchen, NJ (US)

(21) Appl. No.: 11/995,629

(22) PCT Filed: Aug. 1, 2006
(86) PCT No.: PCT/US2006/029792

§ 371 Date: Jan. 14, 2008

Related U.S. Application Data
(60) Provisional application No. 60/704,260, filed on Aug. 1, 2005.

(51) Int. Cl. G06F 17/30

(52) U.S. Cl. 707/104.1; 707/10

(57) ABSTRACT

Certain exemplary embodiments can be used to implement a method, system, device, software program product, machine-readable medium, signal, and/or user interface for, among other things: automatically down-sampling a first version of a digital image product to a second version; automatically uploading or downloading a predetermined version of the digital image product; automatically applying a transformation to a predetermined version of the digital image product; and/or automatically synchronizing versions across a server and/or multiple clients.

### CROSS-REFERENCES TO RELATED APPLICATIONS

This application claims priority to, and incorporates by reference herein in its entirety, pending U.S. Provisional Patent Application Ser. No. 60/704,260 (Attorney Docket No. 1087-002), filed 1 Aug. 2005.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system;

FIG. 2 is a flowchart of an exemplary embodiment of a method;

FIG. 3 is a flowchart of an exemplary embodiment of a method;

FIG. 4 is a flowchart of an exemplary embodiment of a method;

FIG. 5 is a flowchart of an exemplary embodiment of a method;

FIG. 6 is a flowchart of an exemplary embodiment of a method;

FIG. 7 is a screenshot of an exemplary embodiment of a user interface;

FIG. 8 is a screenshot of an exemplary embodiment of a user interface;

FIG. 9 is a screenshot of an exemplary embodiment of a user interface;

FIG. 10 is a screenshot of an exemplary embodiment of a user interface;

FIG. 11 is an entity-relationship diagram of an exemplary embodiment of a database schema;

FIG. 12 is a flowchart of an exemplary embodiment of a method;

FIG. 13 is a flowchart of an exemplary embodiment of a method;

FIG. 14 is a block diagram of an exemplary embodiment of a system; and

FIG. 15 is a block diagram of an exemplary embodiment of an information device.

### DETAILED DESCRIPTION

Still images from modern digital cameras are oftentimes large and their size continues to increase. Typically in JPEG format, fall-size images from cameras today can range from approximately 1 megabyte (MB) to over 6 MB in total size (file size). The file size can depend on the resolution of the camera (in megapixels or MPs) and/or the JPEG compression ratio achieved by the camera when compressing the image. Today's cameras typically create images containing from approximately 3.3 MP to approximately 8 MP and as the technology matures, newer cameras have increased MP ratings, yielding ever larger images.

Most camera users want to do two main things with their digital images: share them with others and make prints. A convenient way to share pictures with others is to upload them to a central server that has a good high-bandwidth connection to the Internet so that others can view the pictures quickly and efficiently with a web browser fetching the images from the well-connected central server. Because computer monitors typically have a dot pitch of between 75 and 110 pixels per inch, smaller size, down-sampled, versions of the image can be best for online viewing. Conversely, printing the image, either through Internet-connected photo finishers or on a personal printer can require the fall-size image to obtain the best results. Unfortunately, most users have very limited upload bandwidth, and uploading a single fall-size image can take from tens of seconds to a few minutes depending on the upload bandwidth and/or the size of the image. Waiting for entire albums of full-size images to upload can make for a very poor experience for the end camera user.

A potentially desired approach can be one that enables fast transfer of images from personal computers to central servers for online sharing and stores fall size images (for printing).

Certain exemplary embodiments can be based on the following observations:
online viewing of a photo typically requires only a down-sampled version of the associated image;
display screens are typically much lower resolution than the original photos; and/or
down-sampling a digital image on a personal computer can take very little time because the image data can be close to the CPU.

Certain exemplary embodiments can incorporate these observations into a high-productivity upload system for digital images and/or files. When a camera user imports images into certain exemplary embodiments, the following actions can be taken:
the images can be automatically down-sampled locally on the computer of the camera user/manager. At least two sizes can be generated, a thumbnail and a web-size image suitable to provide a quality viewing experience on the web, but significantly smaller than the full-size image. The down-sampled images can be immediately viewable in an application running on the camera user/manager's computer.
the down-sampled versions of the images can be automatically uploaded to the central server. These uploads can be fast because down-sampled resolution images are typically much smaller than full-size originals. The consumer perception can be that the image upload occurs very quickly.
full-size original images can be automatically sent to the central server in the background while the consumer continues to work locally with their images and/or views the down-sampled images on the Internet.

Down-sampling locally, then uploading down-sampled images first and full-size images later, in the background, can provide a dramatically improved experience for the consumer. The camera user/manager can remain productive and/or can continue editing their album locally (e.g., captioning images, removing images, and/or rotating images, etc.), even while the full-size originals are uploading in the background. All the while, their down-sampled web albums can be available sooner than in other import processes that require users to wait for the completion of full-size uploads before viewing albums or editing the album or images. In certain exemplary embodiments, although the albums can be ready for immediate viewing on the web once the small down-sampled images are uploaded, web links for full-size originals, prints, and/or other services that require full-size images can appear only after the full-size images are uploaded.

Certain exemplary embodiments can utilize zero-click publishing. Camera users/managers can begin the high-productivity import process described above simply by dragging images into a client application (or choosing them via a file import menu) and dropping them in an album. The down-sampling and the uploading of those down-sampled images to the central server can begin immediately and automatically. There need be no “publish” button or other explicit user command to initiate the down-sampling and/or uploading. Further, all open clients can stay coherent (or in sync) with the central server regardless of the source of any transformations to a digital image product. This background, automatic, multi-computer synchronization can allow for seamless account management from multiple PCs—that is, one can simply start the Phanfare client application on another PC and that client application can automatically sync to the state of the central server. A coherence mechanism can ensure changes made in one client are reflected in all other open clients (or the next time another client is started).

### Implementation Details

In this section we discuss certain exemplary embodiments, referred to herein as the “Phanfare” system, beginning with a high-level description of an exemplary five main components of the Phanfare system: the web service, the backend database, the web server (different than the web service), the web browser, and the client application.

### Phanfare Web Service

The Phanfare Web service can be a server-based system that can implement an API (software application programming interface) to receive full-size and/or down-sampled digital images and/or return information about albums, images (potentially of all resolutions), videos, and/or user accounts needed to display online albums over the Internet via the world wide web.

The Phanfare Web service can contain all of the code and/or logic to handle coherence between multiple Phanfare Client Applications, so that users can manage their albums from multiple PCs. Further, it can handle coherence issues (even with only a single client) that can stem from the separate upload of down-sampled images first followed later by the full-size image. For example, if the user imports an image and then rotates that image to the right, the server (which can have the down-sampled image but say, has yet to receive the full-size image) can be notified of the rotation and the online album can immediately reflect this change. When the full-size (unrotated) original image is later uploaded to the server, the web service can apply all of the transforms that the user has applied to the image in the interim so that it is consistent with the down-sampled image. In fact, the web service can regenerate the down-sampled images once it applies the transformations to the higher quality full-size image. Likewise, because the user can transform a file that contains an image, e.g., by modifying the file name, owner, access privileges, etc., by receiving sufficient information about these transformations, the web service can apply these metadata transformations to the server's copy of the file. In fact, the user can transform the data and/or metadata while off-line, and once connected to the Internet, the Phanfare Client Application can transmit information about those transformations to the Phanfare Web service so that the transformations can be mirrored on the server's copy of the data and/or metadata and synchronized with any other clients.

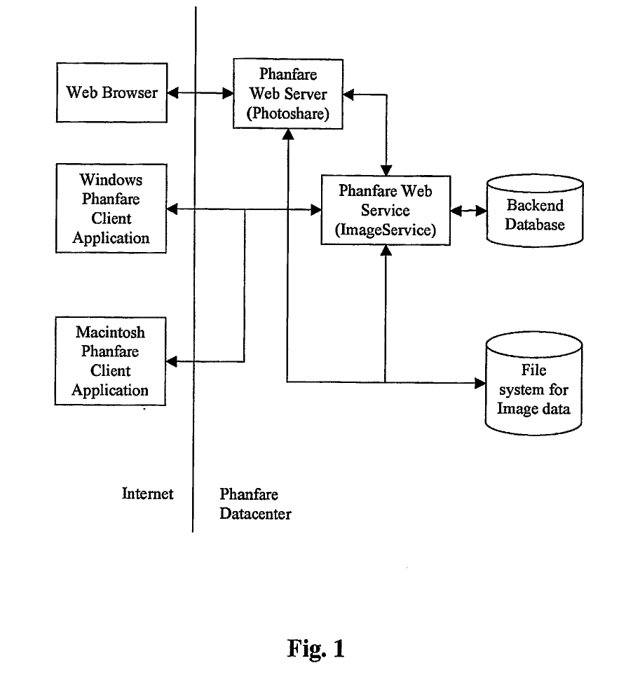

The Phanfare Web service API can be invoked both by the Phanfare Client Application that manages the online album for the Phanfare customer and by the web server when it displays the online album via the world wide web. A diagram of an exemplary embodiment of the overall Phanfare architecture and/or system can be seen in FIG. 1.

An exemplary embodiment of the Phanfare Web Service is called the ImageService, and can be written in C# as a Microsoft .NET Web Service.

### Backend Database

As described above, metadata, such as metadata about users, albums, images, videos, privileges, sessions, and/or usage data, etc., can be stored in a relational database such as Microsoft SQL server and/or Microsoft Access. The web service methods above can query the backend database to add or update new information about the online album, and/or when requested to retrieve information about users, albums, images, videos, privileges, sessions, and/or usage, etc.

The backend Phanfare database can keep a large number of tables in its schema to keep things general. However, the rough structure of the backend database can be described as a set of tables containing at least some of the following information: registered users (and associated user information), albums owned by each user, digital image products contained in each album, valid sessions and privileges associated with a particular web cookie, and/or system usage statistics for debugging and performance monitoring, etc. The database itself can run on the same machine as the Phanfare web service or it can be a separate standalone server.

Note that the backend system can be limited to storing metadata only. The actual digital image product data can be stored in an explicit database and/or regular file systems (i.e., not in an explicit database), either of which can be accessible to the Phanfare web service.

### Phanfare Web Server

The Phanfare Web Server can be software system that is a client of the Phanfare Web Service and/or can render HTML representations of online albums over the world wide web. Friends and family viewing the online albums can point their web browsers at the Phanfare Web Server. The web server can make calls to the Phanfare Web Service to retrieve the necessary information to render the page being requested.

The Phanfare Web Server can be stateless. Browser cookies can be used to authenticate web browser requests for particular albums and/or digital image products. Cookies can be used to convey user preferences, such as, for example, the resolution at which to show web-sized images (users with smaller displays can view smaller images).

Certain current embodiments of the Phanfare Web Server are called Photoshare. It is written in C# and ASP.NET and can take HTTP requests from a web browser, translate those requests into web service calls, and/or return HTML to the requesting web browser. Photoshare can use ASP.NET's code-behind HTML forms system. Visual elements can be contained in .aspx files. Controller elements can be contained in code-behind .cs (c#) files. There also can be an ISAPI filter that can rewrite certain nice looking URLs like: “http://” followed by “username.phanfare.com/” to the proper .aspx ASP.NET script.

The online slideshow can be implemented as a Flash movie (.swf file) and/or can require the viewer's web browser to have the Flash plug-in.

### Web Browser

Phanfare's online albums can be viewed from any web browser (PC or Mac). No special browser software is necessarily needed, though the browser can be configured to allow cookies so that authentication can work properly. This is the default setting for all popular web browsers. As mentioned above, the Phanfare slideshow can require the Flash plug-in from Macromedia (now Adobe). If not already present on the machine, the need for the plug-in can be automatically detected and the plug-in can be downloaded and installed.

Each Phanfare user can be given a unique usemame, and/or their albums can be viewable online at username.phanfare.com, where usemame can be the user's Phanfare username. The Phanfare Web Server can support custom domain names. If the user creates a CNAME record for their custom domain name to point to www.phanfare.com and notifies Phanfare via the Phanfare client application (next section), the Phanfare Web Server can serve online album pages via the custom domain name.

The web browser can view the down-sampled images (thumbnails and web-sized images), but links can be provided to download the fall-size image if desired. Links can be available for ordering prints and/or gifts, which can require the full-size image to be present on the server.

### Phanfare Client Application

The Phanfare Client Application (Phanfare Photo) can be a downloadable application that the consumer can use to upload and/or manage photos, videos, and/or other digital image products from their personal computer. Phanfare Photo can be multithreaded to permit background uploading while the consumer organizes and/or edits images in the foreground.

Phanfare Photo can include any of the following non-exhaustive list of features:
a subsystem to down-sample images;
a subsystem to upload down-sampled images in the background while the camera user/manager organizes and/or edits photos;
a subsystem to upload fall-size original images in the background;
automatic Zero-click publishing of digital image products;
local first-frame extraction of imported videos;
EXIF parsing of digital images;
optional auto-dating of albums based on EXIF image dates;
optional auto-captioning of images based on certain EXIF fields;
local image transformations (e.g., rotate, auto-levels, crop, red-eye, and/or brightness/contrast, etc.) that can be saved on the server to be applied to the fall-size image there once it is present;
an ability to “sync” with the Phanfare Web Service to reflect changes made by other instances of Phanfare Photo, including logic to resolve conflicts;
integrated album/website invitation tools;
coarse and/or fine-grained permission control for website/album access; and/or
an ability for a consumer to change the style/color scheme of their website and/or album.

### Phanfare System Diagram and Usage Flowcharts

A block diagram and/or high-level overview of certain exemplary embodiments of the Phanfare System Architecture, illustrating the components described previously, is shown in FIG. 1. Note that the “server” components to the right of the dashed line are shown as located in the Phanfare data center. These components are the Phanfare Web Server (Photoshare), the Phanfare Web Service (ImageService), and the Backend Database. The Web Service can query the database as necessary to store and/or retrieve metadata information on behalf of the Web Server and/or the Phanfare Client Application. Digital image product data can be directly accessed by the Web Server and/or the Web Service via a network file system.

To the left of the dashed line are the components that can be located outside of the Phanfare data center. These can include the Web Browser, which can be used by anyone with permission to access the online albums, and the Phanfare Client Application, which can be the downloadable management software for the camera user/manager that can run on their PC or Mac and/or allow them to create, edit, and/or manage their Phanfare online albums. While the Web Browser can communicate with the Phanfare Web Server, the Phanfare Client Applications can communicate directly with the Phanfare Web Service.

### Flowchart of a Typical Import/Uploading Session

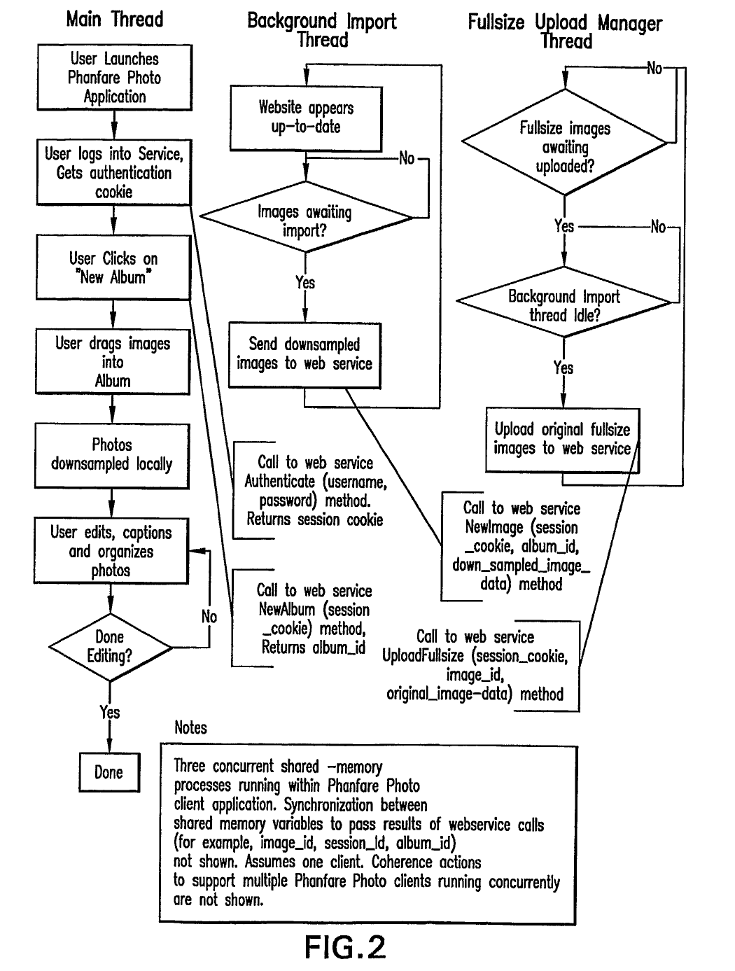

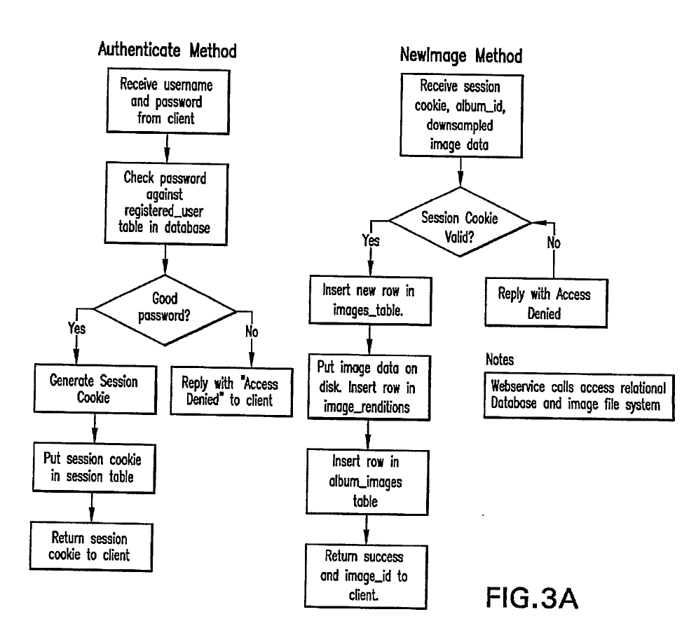

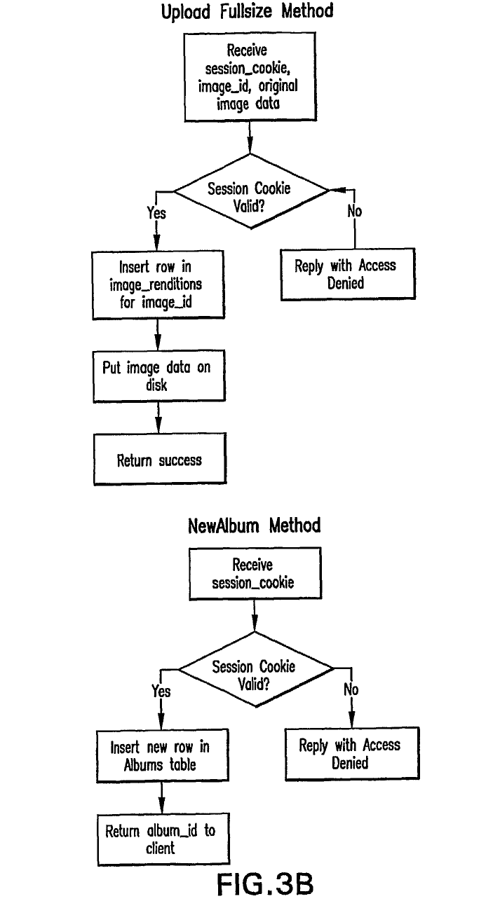

FIGS. 2 and 3 are flowcharts of exemplary embodiments of methods that relate to Phanfare Photo, which can be a client application having multi-threaded windows, and to the web service which can be used for the creation of an album and/or the importing of digital image products for an existing user account, respectively.

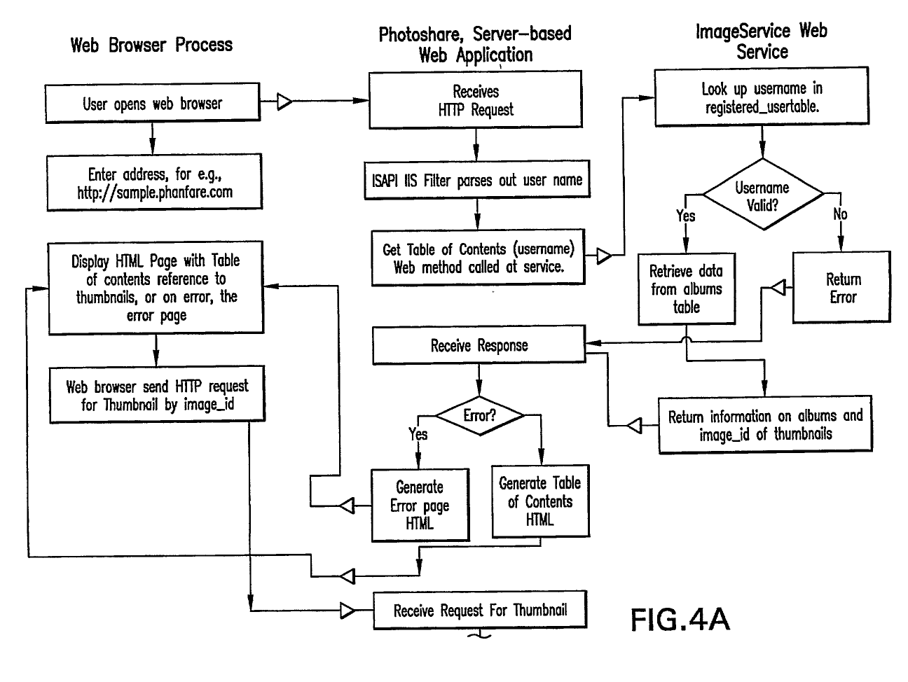

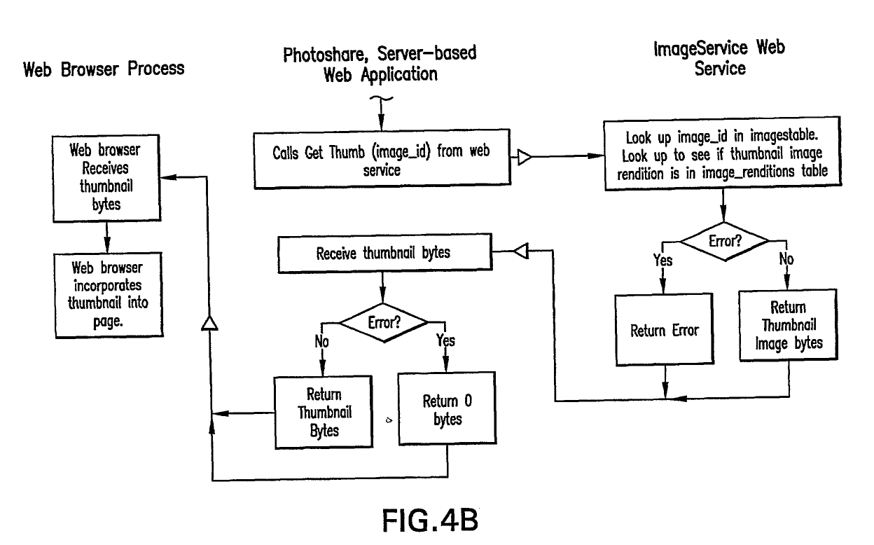

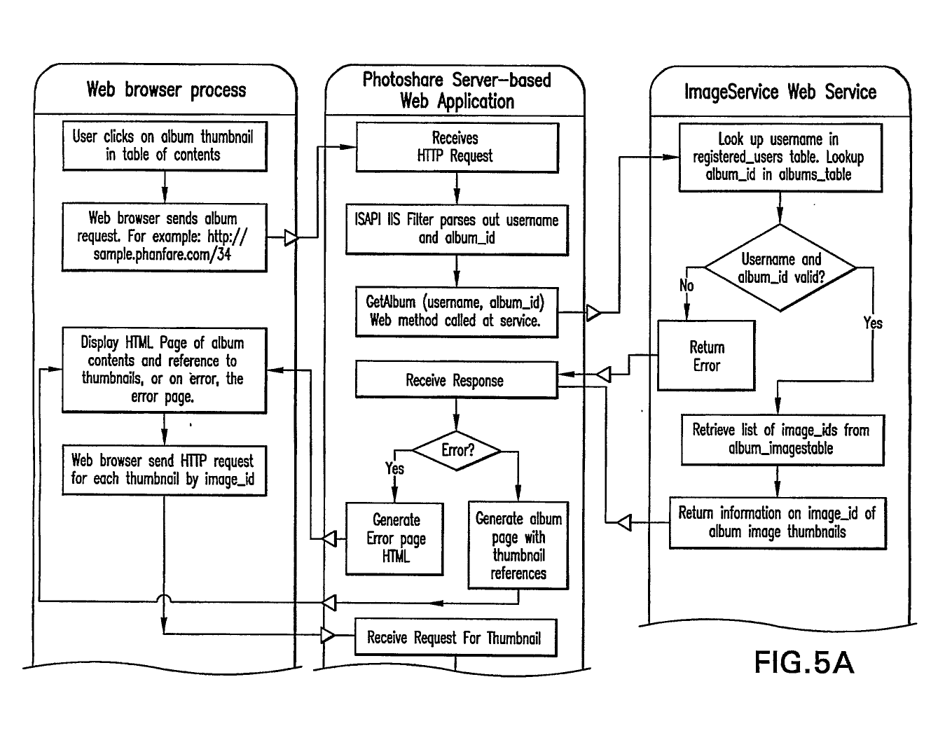

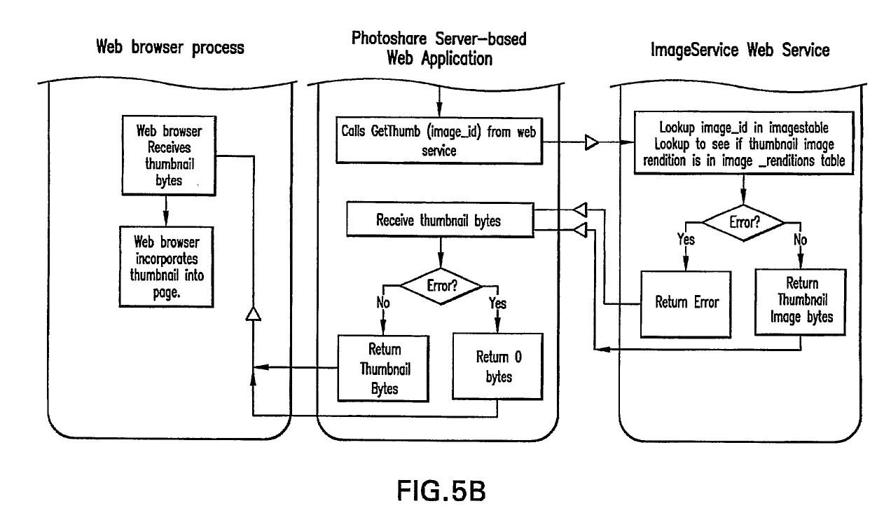

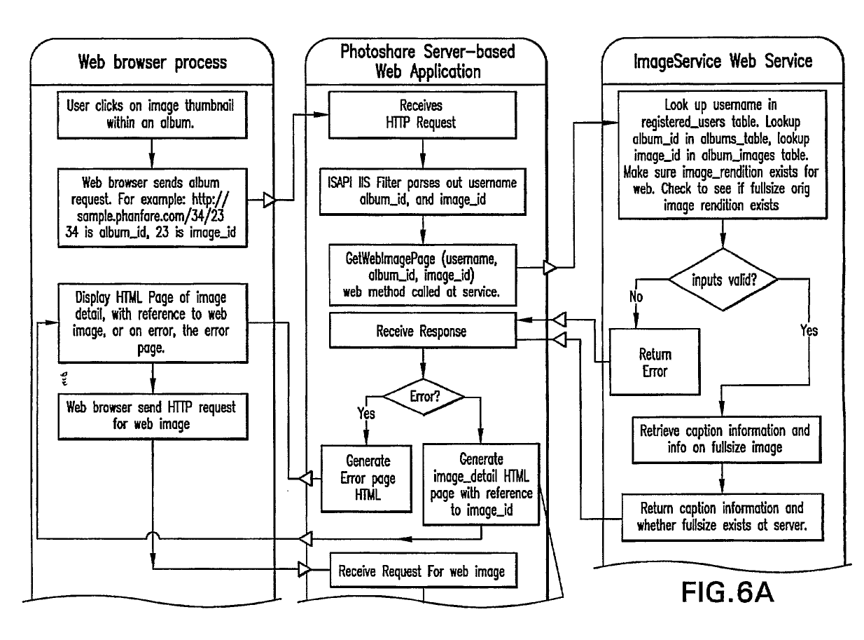

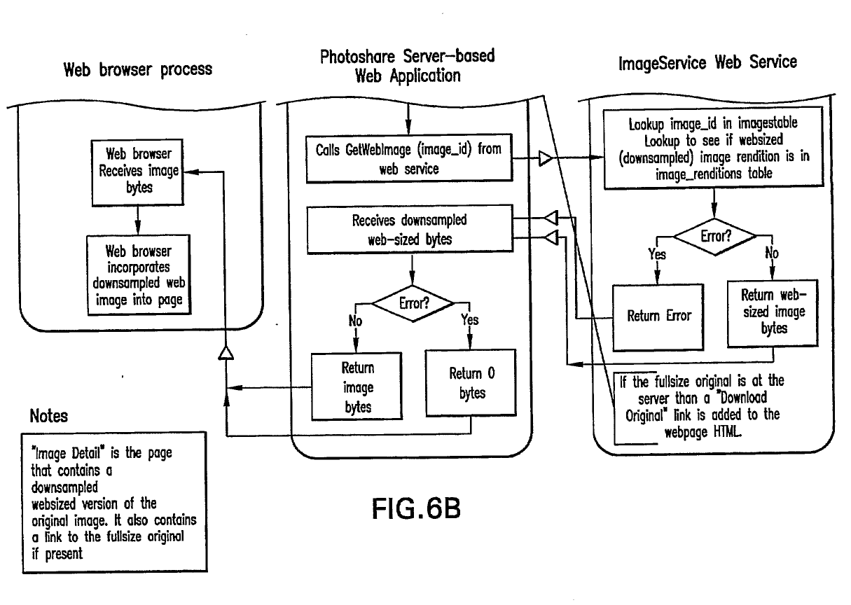

FIGS. 4, 5, and 6 are flowcharts of exemplary embodiments of methods that relate to potential interactions between the Phanfare client and server and/or services for requesting, receiving, and/or viewing an album table of contents, album, and/or image, respectively.

### Screenshot of Phanfare Client Application

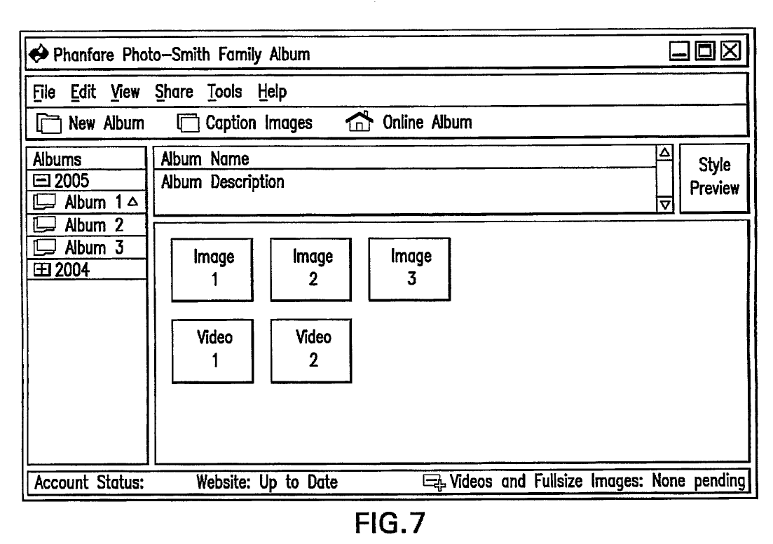

FIG. 7 is a screenshot of an exemplary embodiment of a user interface that shows the Windows Phanfare Client Application managing a sample account. The screenshot showing the 4^{th} of July album is selected (in the Albums pane at the left) and thumbnails from that album are displayed in the larger pane on the right. Users can create new albums by clicking on New Album. Users can import digital image products into the album by dragging images into the Phanfare Client Application and dropping them in the thumbnail panel.

Screenshots of Phanfare Online Sample Album from a Web Browser

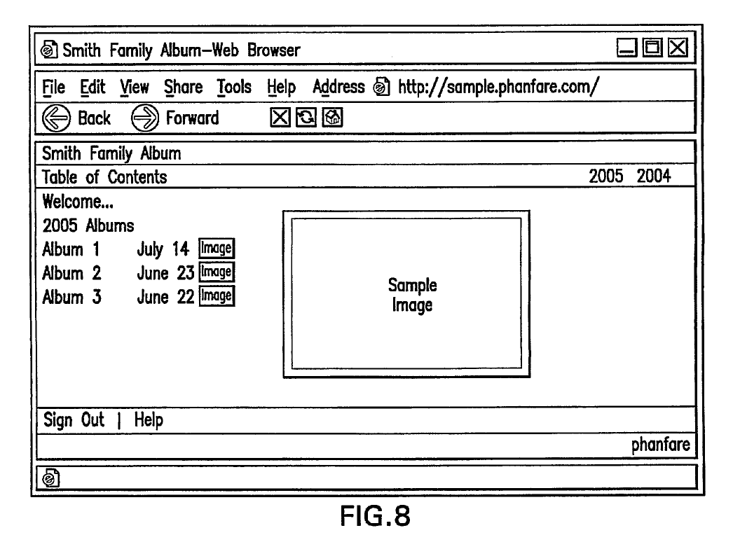

FIGS. 8, 9, and 10 are screenshots of exemplary embodiments of a user interfaces that relate to a web browser viewing an album online at sample.phanfare.com. FIG. 8 shows the Table of Contents page, which can contain an album listing, and/or small thumbnails of an image from each album, and/or a larger featured image.

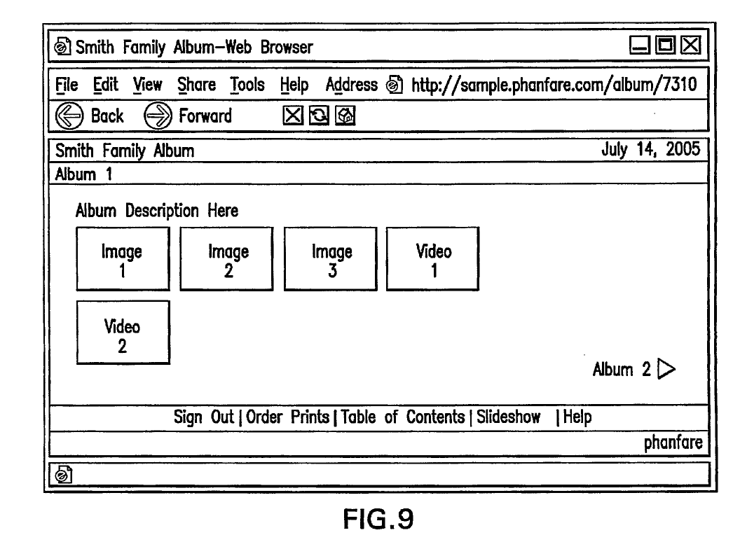

FIG. 9 shows an album page, which can contain thumbnails of each digital image product and/or one or more of its component images in the album, and/or the album description (narrative).

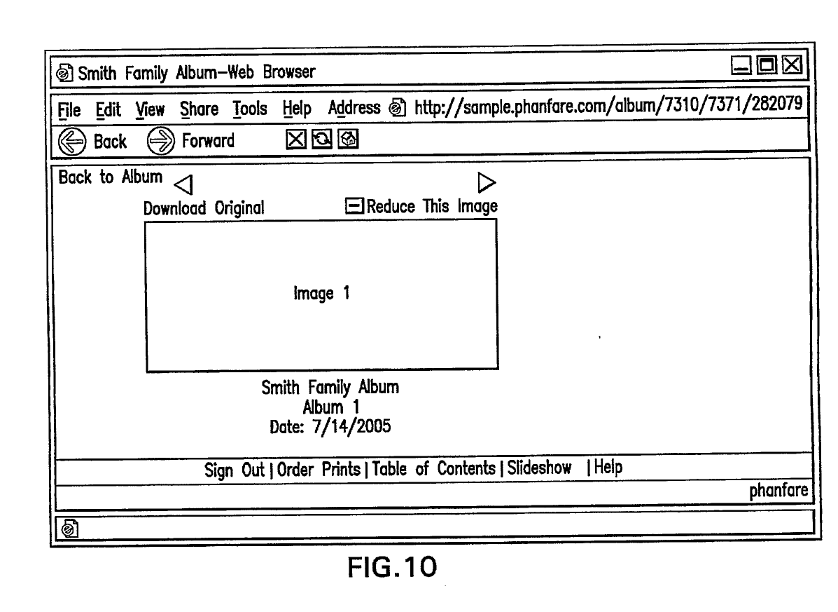

FIG. 10 shows an image detail page, which can contain a single larger digital image product and/or one or more of its component images appropriate for web viewing, and/or the caption of the digital image product and/or one or more of its component images.

### Backend Database Core Schema

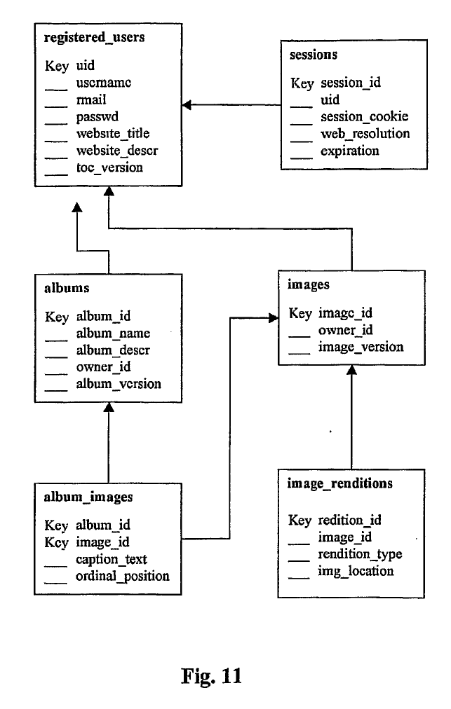

FIG. 11 is an entity-relationship diagram of an exemplary embodiment of a basic relational database schema, which can support the Phanfare System of creating online albums, such as via the Phanfare Backend Database. Among other things, the schema can support the presence of multiple image renditions for a given image. Images can be assigned an image_id, and rendition_type can include FULL_SIZE, WEB, and/or THUMBNAIL. This information can be kept in the image_renditions table. The main images table can track all digital image products and/or one or more of their component images by their image_id and/or the uid of the user that owns that image. Because images can change as they are transformed by the user (e.g. rotation, crop, and/or red-eye, etc.), the images table can assign an image_version to each digital image product and/or one or more of its component images. This version information can be used to keep images coherent across multiple Phanfare Client Application instances.

Phanfare can organize the users' digital image products and/or one or more of its component images into albums, and/or can keep information about each album in the albums table. Each album can have a unique album_id a title (album_name), and/or an overall album description. The albums table can record the uid of the user that owns the album and/or the album_version. Like images, albums can change as the user edits their album in the Phanfare Client Application, and the album_version can be used to keep albums coherent across multiple Phanfare Client Application instances.

The album_images table can track the information about each digital image product and/or one or more of its component images in the album. This information can include the album_id, and/or image_id identifiers for the digital image product and/or one or more of its component images, and/or the image caption and/or its ordinal position within the album. The image_id can identify the digital image product and/or one or more of its component images in the images table.

The registered_users table can record known information about the users in the system and/or assign each user a unique user_id (uid). The uid can be used to track the owner of albums and/or digital image products and/or one or more of its component images in those respective tables, and/or can be used in the sessions table to ensure the proper album security. Aside from holding various account information about the user, the registered_users table can hold website-level information about the user's Phanfare website. For example, the username (where the user's albums appear at username.phanfare.com/), the title of their website (e.g. John Smith's Albums), and/or a toc_version that indicates the current version of the Table of Contents (TOC) can be provided. The toc_version can change whenever anything beneath it in the hierarchy changes (any album and/or any image and/or any video). Special triggers can be set up in the backend database to automatically increment toc_version when information changes regarding an album, digital image product, and/or one or more component images. Similarly, the album_version discussed earlier can be bumped via a trigger whenever any of its digital image products and/or one or more of its component images change.

Finally, the sessions table can be used to manage proper authentication to online albums. Viewers of online albums who have properly authenticated themselves can be given a session_cookie with a given expiration. Each session cookie can have a known set of TOC and/or album privileges. Album pages can be viewed, potentially only by web browsers that present valid session cookies for that page.

### Maintaining Coherence Between Multiple Client Applications

The Phanfare system can keep multiple Phanfare Client Applications coherent with the server. This means when one client changes image data and/or any associated metadata (e.g. image captions, album descriptions, website name, etc.) those changes can be reflected not only on the server but also on all other Phanfare Clients.

Certain exemplary embodiments of the Phanfare Client Application can keep coherence as follows:
When the Client Application starts it can call a local Validate( ) routine that can ensure that any locally cached information is consistent with that on the server. One possible Validate( ) algorithm is discussed below. This algorithm can handle the case where changes are made to the server by another Client while this Client was not running.
The Client Application can launch a background thread that periodically calls Validate( ) without user initiation. This algorithm can handle the case where another running Client makes changes to the server while this Client is running.
Two or more running instances might make or attempt to make conflicting changes (e.g. change the same album or image in the same or conflicting ways). In this case the Phanfare Web Service can reject the later, conflicting change and/or inform the Client making the change that its attempt has failed. The Phanfare Client then can call Validate( ) to become consistent with the server.

Validate( ) can work by leveraging the version numbers kept hierarchically by the Backend Database. As shown in the example core schema, the database can keep a version number on the user's entire website (Table of Contents or toc_version, kept in the registered_users table), a version number for each album (album_version, kept in the albums table), and a version number for each digital image product (image_version, kept in the image table). These version numbers can be hierarchical in the sense that whenever the user writes in any way to an album, the album_version can increment and therefore the toc_version for the overall website can increment as well. Similarly, whenever the user writes/changes an image product in any way, the albums containing that image product on the server can have their album_versions incremented by the Backend Database, and the toc_version therefore can increment as well. Since Validate( ) can run on the Phanfare Client Application, which can track the version numbers of the Table of Contents, albums, and/or image products it has locally, the Validate( ) routine can need only to make calls to the Phanfare Web Service to ensure that the local versions are the most recent.

A certain exemplary embodiment of the Validate( ) call in the Phanfare Client Application can take the following actions:
Make a Phanfare Web Service GetTOC( ) call. This call can return the version number of the Table of Contents (toc_version) on the server. Because of the hierarchical nature of the Phanfare coherence versioning scheme, if the toc_version on the server is equal to the toc_version locally, the Client can be considered to be consistent with the server and Validate( ) can return after making only a single call to the Phanfare Web Service.
However, if the toc_versions are not equal, Validate( ) can check all the album_versions for each album in the local TOC, to see if they match those on the server. If the local TOC has an album that is no longer on the server (not listed in the TOC returned by the GetTOC call above) then Validate( ) can know that album has been deleted by another Client and/or can locally delete that album from its Client.
If the local TOC has an album that is still on the server but has an out-of-date version number, it can make a Phanfare Web Service GetAlbum( ) call to retrieve the latest version of that album, discarding the old local version.
Finally, for each album that was out of date, Validate( ) can check the version number of the local image products in that album with those on the server (this information can be returned in the GetAlbum( ) call). If the local image_data is out-of-date Validate( ) can either remove the image products locally and let them be demand fetched in as needed or it can elect to make a Phanfare Web Service GetImage( ) call to fetch the image data proactively. Any image products that were in the old album but not present at all in the new album can be locally removed.

The ImageService web service can be responsible for assuring that no changes to a user's account occur from a Phanfare Photo client that does not have up-to-date information. The ImageService also can be charged with maintaining the table_of_contents version numbers (kept in registered_users.toc_version), the album version numbers (kept in albums.album_version), and/or the digital image product version numbers (kept in images.image_version).

All version numbers can start at 0 and/or can be incremented by one for each change. To simplify maintenance of the version numbers, database triggers on the image_renditions, image products, album_images, albums, and/or registered_users table, etc., can automatically increment the appropriate version number and/or cause a cascade by touching the containing table. Here is possible pseudo-code for the triggers on each table.

```
            ImageRenditions Table Trigger
For each row deleted, updated or inserted
{
    Touch column in containing images table
    to cause cascading version increment.
}
                Image Table Trigger
For each row deleted, updated or inserted
{
    Increment version number;
    Touch column in containing album to cause
    cascading version increment;
}
                Album_images Table Trigger
For each row deleted, updated, or inserted
{
    Touch column in containing album to cause
    cascading version increment;
}
                  Albums Table Trigger
For each row deleted, updated or inserted
{
    Increment album version number;
    Touch colunm in containing registered
    users table to cause cascading version
    increment;
}
                Registered_users Table Trigger
For each row deleted, updated or inserted
{
    Increment version number;
}
```

Each ImageService function that modifies a user's account can take a version number as an argument. The Phanfare Web Service can easily check whether or not the caller has the most recent version of the account information by checking the toc_version number. If the caller does not have the most recent version, a coherence violation can be flagged and/or the client call can be not allowed to succeed. That is, when a client is ready to write a transformation and/or new version to the server, the client can, for example, send the proposed transformation and/or new version to the server along with the client's version number. Regardless of how the version numbers are communicated between the client and server, if the client's version number does not match the server's version number, the modification to the server's version can be rejected. At that point, the client's version can be updated to match the server's version, and the client can apply the saved transformation to the updated version. Then, after validating version numbers, that transformed version can be written to the server to bring the server in synch with the client's version.

Under normal operation, coherence violations need not arise because Phanfare Photo, if left running, can periodically validate itself against the service and/or bring down the latest versions of all user data. Coherence violations can occur if a user is controlling two running instances of Phanfare Photo simultaneously.

A coherence violation can result in the user's modification (such as a caption change) being rejected while the client Validates itself and brings down the most recent copy of the account for local manipulation at the client.

Here is an example web service call with coherence logic:

```
            NewImage ImageService Method
ReturnCode NewImage(session_cookie, toc_version,
    Album_id, image_data, out new_toc_version)
{
    // this function is used to add an image to
    // existing album.
    Username = SessionToUsername(session_cookie);
    If (usename not valid) return ERROR;
    If (owner(album_id) <> username) return ERROR;
    Current_toc_version = GetTocVersion(username);
    If (toc_version < current_toc_version)
    {
        Return COHERENCY_VIOLATION;
    } else {
        // code to add an image to an album
        Insert row into images table;
        Insert row into image_renditions table;
        Add image_data to the file system;
        Add row to album_images for album_id;
        Return new toc_version (which will have
        Changed in the course of updating data due to
        triggers;
    }
}
```

All ImageService methods that modify user state can take as an argument the toc_version of the caller and can return the new toc_version as incremented that can exist as a result of the changes made. Phanfare Photo can incorporate the new version number into its own state so that subsequent calls can include an updated version number. Otherwise, future calls can be rejected.

The toc_version can be the final arbiter of a user's account. The album-level and image-level version numbers can be used to quickly determine, during client Validate( ), which parts of the account have changed and which are up-to-date.

Via the Phanfare synchronization method, opening a Phanfare Client Application that is empty, such as because of a disk crash and/or natural disaster, can cause that Phanfare Client Application to be automatically populated, thereby locally restoring its state.

### Extension to Other Digital Image Products

Certain exemplary embodiments can allow similar importing, down-sampling, uploading, sharing, and synchronizing of any of a wide range of digital image products. For example, a variety of video formats can be imported into the Phanfare Client Application. The Phanfare Client Application can locally extract the first frame of the video and/or down-sample it to create a web-sized version and/or a thumbnail, as if it were a digital photo and not a video. Then a high-productivity import process can be followed: the down-sampled images can be uploaded to the server first, allowing the user/manager to continue working on their album in the foreground. Later, the full-size video can be uploaded to the server in the background. Although like with still images, a viewer can immediately view the first frame still image of the video on the online photo album, depending on the down-sampling technique, the viewer will not necessarily be able to play the video until the fall-size video is uploaded.

However, the high-productivity import process can be extended to address this issue. Like still digital photos, digital image products, such as videos, animations, etc., can be heavily compressed (down-sampled) locally on the client computer and those heavily compressed, smaller versions sent to the Phanfare Web Service initially. In the background, higher quality versions of the same digital image product can be sent to Phanfare Web Service. With such a process, end users can view low quality digital image products versions sooner and high quality ones once they are uploaded to the service.

Certain exemplary embodiments can be used to implement a method, system, device, software program product, machine-readable medium, signal, and/or user interface for, among other things: automatically down-sampling a first version of a digital image product to a second version; automatically uploading or downloading a predetermined version of the digital image product; automatically applying a transformation to a predetermined version of the digital image product; and/or automatically synchronizing versions across a server and/or multiple clients.

Certain exemplary embodiments can be used to implement a method, system, device, software program product, machine-readable medium, signal, and/or user interface adapted for, among other things: automatically, and without utilizing a web browser, uploading a first version of a digital image product from a first client information device to a predetermined server after a second version of said digital image product is automatically uploaded from said first client information device to said predetermined server, said second version automatically created by down-sampling said first version, said first version characterized by a first value of a digital image product quality variable, said second version characterized by a predetermined second value of said digital image product quality variable that is less than said first value.

Certain exemplary embodiments can be used to implement a method, system, device, software program product, machine-readable medium, signal, and/or user interface adapted for, among other things: applying, via a first client information device, a user-requested transformation to a predetermined version of a digital image product while a first version of said digital image product is automatically uploaded from said first client information device to a predetermined server and without interfering with said applying said user-requested transformation, said first version automatically uploaded after a second version of said digital image product is automatically uploaded from said first client information device to said predetermined server, said second version automatically created by down-sampling said first version, said first version characterized by a first value of a digital image product quality variable, said second version characterized by a predetermined second value of said digital image product quality variable that is less than said first value.

Certain exemplary embodiments can be used to implement a method, system, device, software program product, machine-readable medium, signal, and/or user interface adapted for, among other things: applying, at a predetermined server, a transformation to a first version of a digital image product, said transformation previously applied at a first client information device, said first version automatically received from said first client information device at said predetermined server after a second version of said digital image product was automatically received from said first client information device at said predetermined server, said second version a down-sampled version of said first version, said first version characterized by a first value of a digital image product quality variable, said second version characterized by a predetermined second value of said digital image product quality variable that is less than said first value, said predetermined server not storing a transformed version of said digital image product resulting from application of said transformation at said first client information device.

Certain exemplary embodiments can be used to implement a method, system, device, software program product, machine-readable medium, signal, and/or user interface adapted for, among other things: in response to an automatic version request received from a non-browser application running on a first client information device, automatically providing, to said first client information device, a server-side version of an digital image product stored remote from said first client information device, said server-side version automatically determined to not match a client-side version of said digital image product stored local to said first client information device.

Certain exemplary embodiments can be used to implement a method, system, device, software program product, machine-readable medium, signal, and/or user interface adapted for, among other things: in response to an automatic version request received from a non-browser application running on a first client information device, automatically providing, to said first client information device, a server-side version of an digital image product stored remote from said first client information device, a hierarchical version number of said server-side version automatically determined to not match a hierarchical version number of a client-side version of said digital image product stored local to said first client information device.

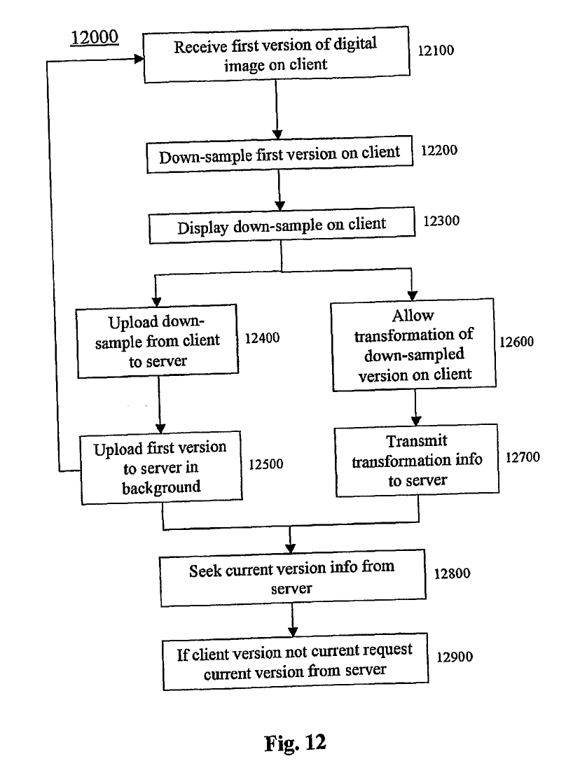

FIG. 12 is a flowchart of an exemplary embodiment of a method 12000. At activity 12100, a digital image and/or digital image product can be received on a client information device and/or by a client software program product, such as from a digital image production device, such as an information device, digital camera, and/or video camera. The digital image product can be, for example, a digital photo or a digital video. Whether the digital image product has been previously modified or not, for the context of describing this method, it can be considered an initial, first, and/or original version of the digital image product with respect to this particular client.

At activity 12200, the first version can be automatically down-sampled on and/or via the client to create a second version of the digital information product. At activity 12300, the second version can be displayed on and/or via the client. At activity 12400, the second version can uploaded from the client to a predetermined server. At activity 12500, the first version can uploaded from the client to a predetermined server. The first version can be uploaded before, during and/or after uploading of the second version. At activity 12600, before, during, and/or after uploading of the first and/or second version, a transformation of the first and/or second version can be received, allowed, and/or applied on and/or via the client. At activity 12700, before, during, and/or after uploading of the first and/or second version, information regarding the transformation can be transmitted to the server. At activity 12800, the client can request and/or obtain from the server information regarding the version stored on the server and/or the current version. At activity 12900, if the client's most recent version is older than the server's most recent version, the client can request and/or obtain from the server the server's most recent version.

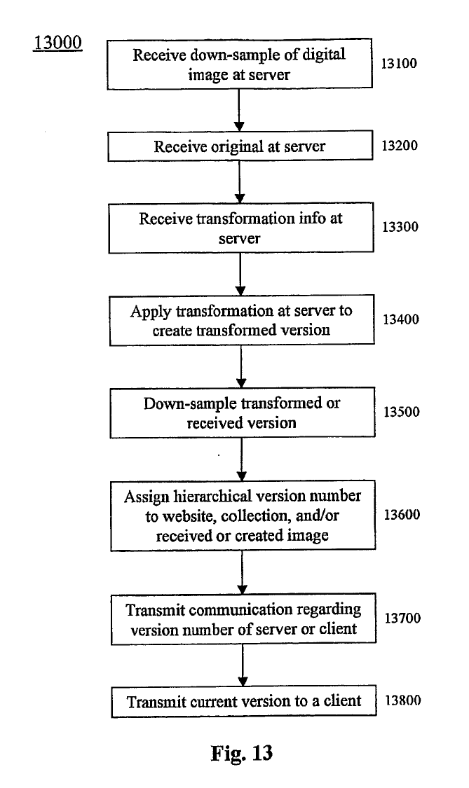

FIG. 13 is a flowchart of an exemplary embodiment of a method 13000. At activity 13100, a down-sampled (“second”) version of digital image and/or digital image product can be received on a server information device and/or by a server software program product, such as from a client. At activity 13200, a first version of the digital image product can be received from the client before, during and/or after receipt of the second version. At activity 13300, information regarding a transformation performed on the first and/or second version at and/or by the client can be received by and/or at the server. At activity 13400, based on received transformation information, the server can apply a transformation to a received version, such as the first and/or second version, to generate a transformed version. At activity 13500, a received and/or transformed version can be down-sampled by the server. At activity 13600, a hierarchical version number can be assigned by the server to a received and/or server-created website, collection, album, and/or image. At activity 13700, a communication, such as a notification, can be transmitted regarding a version number of a received and/or server-created website, collection, album, and/or image, and/or can be received regarding a version number of a client website, collection, album, and/or image. At activity 13800, potentially upon request of a client, the server's most recent version of a website, collection, album, and/or image can be transmitted to the client and/or to every client.

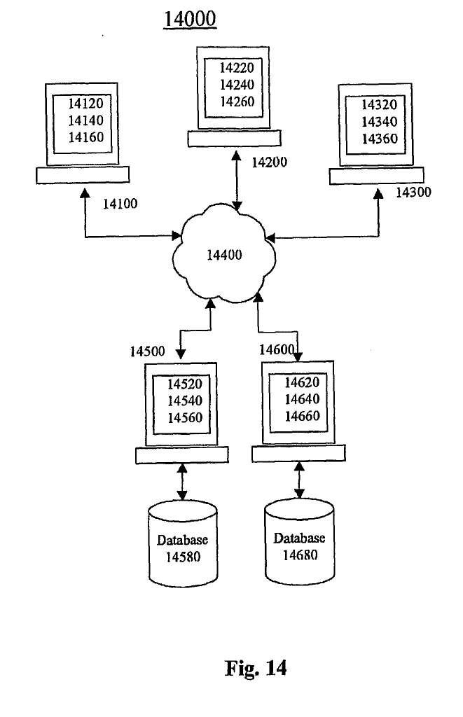

FIG. 14 is a block diagram of an exemplary embodiment of a system 14000, which can comprise a first client information device 14100, a second client information device 14200, and/or a third client information device 14300, any of which can be communicatively coupled to a network 14400. Also communicatively coupled to network 14400 can be a first server information device 14500 and/or a second server information device 14600.

First client information device 14100 can run a client application program and/or processor 14120, such as Phanfare Photo, and/or a browser 14140, such as Internet Explorer, Firefox, Safari, OmniWeb, iCab, Mozilla, Flock, Netscape, Opera, Camino, Konqueror, Galeon, Epiphany, etc., either of which can provide one or more user interfaces 14160. Likewise, second client information device 14200 can run a client application program and/or processor 14220, such as Phanfare Photo, and/or a browser 14240, either of which can provide one or more user interfaces 14260, and third client information device 14300 can run a client application program and/or processor 14320 and/or a browser 14340, either of which can provide one or more user interfaces 14360.

First server information device 14500 can run a web service and/or server application program and/or processor 14520, such as ImageService, and/or a database management program and/or processor 14540, such as the Phanfare Backend Database Management System, either of which can provide one or more administrative user interfaces 14560. Likewise, second server information device 14600 can run a server application program and/or processor 14620, such as PhotoShare, and/or a file system or database management program and/or processor 14640, such as for managing image files and/or an image storage database. Server application program 14620 and/or file system or database management program 14640 can provide one or more administrative user interfaces 14660. Communicatively coupled to first server information device 14500 can be a first database 14580, such as the Phanfare Backend Database, which can be used for storing and retrieving, among other things, image metadata. Communicatively coupled to second server information device 14600 can be a file system storage device and/or second database 14680, which can be used for storing and retrieving image data.

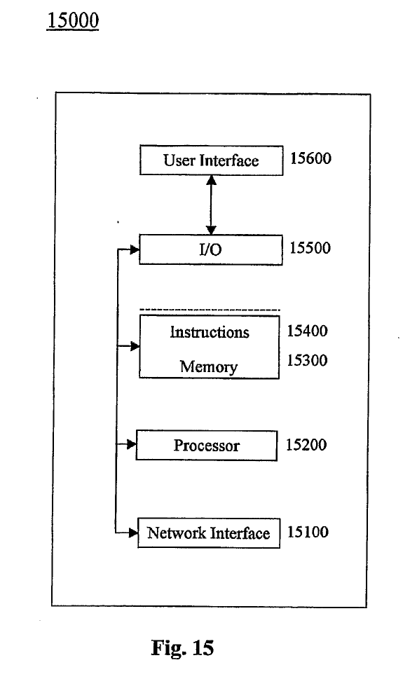

FIG. 15 is a block diagram of an exemplary embodiment of an information device 15000, which in certain operative embodiments can comprise, for example, client information device 14100, 14200, and/or 14300, and/or server information devices 14500 and/or 14600, of FIG. 14. Information device 15000 can comprise any of numerous components, such as for example, one or more network interfaces 15100, one or more processors 15200, one or more memories 15300 containing instructions 15400, one or more input/output (I/O) devices 15500, and/or one or more user interfaces 15600 coupled to I/O device 15500, etc.

In certain exemplary embodiments, via one or more user interfaces 15600, such as a graphical user interface, a user can view a rendering of information related to receiving, transmitting, importing, down-sampling, displaying, uploading, transforming, synchronizing, researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

### Note

Still other practical and useful embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application.

Thus, regardless of the content of any portion (e.g., title, field, background, summary, abstract, drawing figure, etc.) of this application, unless clearly specified to the contrary, such as via an explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, performed by multiple entities, and/or performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, to 3.65, 2.8 to 8.14, 1.93 to 9, etc.

Accordingly, the descriptions and drawings are to be regarded as illustrative in nature, and not as restrictive.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of this patent application, any patent to be granted based on this patent application, or any patent application or patent that claims priority hereto, each definition, as amended and/or redefined during the prosecution of such patent application, functions as a clear and unambiguous disavowal of the subject matter outside of that definition.
activity—an action, act, deed, function, step, and/or process and/or a portion thereof.
adapted—suitable, fit, and/or capable of performing a specified function.
application—the act of putting something to a use and/or purpose; and/or a set of computer-readable instructions and/or a computer program.
applied—incident directly and/or indirectly upon.
apply—to put to, on, and/or into action and/or service; to implement; and/or to bring into contact with something.
applying—to put to use for a purpose.
assign—to designate, appoint, allot, and/or attribute, and/or to select and set apart for a particular purpose.
automatically—acting and/or operating in a manner essentially independent of external human influence and/or control. For example, an automatic light switch can turn on upon “seeing” a person in its view, without the person manually operating the light switch.
cause—to bring about, provoke, precipitate, produce, elicit, be the reason for, result in, and/or effect.
characterize—to define, describe, classify, and/or constrain the qualities, characteristics, and/or peculiarities of.
collection—a plurality of nodes.
communicatively—linking in a manner that facilitates communications.
comprises—includes, but is not limited to, what follows.
comprising—including but not limited to, what follows.
coupled—connected or linked by any known means, including mechanical, fluidic, acoustic, electrical, magnetic, and/or optical, etc.
create—to make, form, produce, generate, bring into being, and/or cause to exist.
current—latest, most recent, prevailing, and/or contemporaneous to the present time.
data—information represented in a form suitable for processing by an information device.
determine—to obtain, calculate, decide, deduce, establish, and/or ascertain.
digital—non-analog; discrete.
digital camera—a camera that captures an image not on film, but via an electronic imaging sensor and associated memory device that takes the place of film.
digital image product—an organized collection of digital image data and/or metadata. A digital image product can comprise a photo, screenshot, icon, logo, graph, chart, figure, map, illustration, painting, drawing, scan, video, web-based video, animations, medical images, satellite images, radar images, thermographic images, and/or infrared images, etc. A digital image product can also comprise text. A digital image product can comprise a vector image or a raster (bit-mapped) image. A digital image product can have any of a wide variety of file formats, such as GIF, BMP, XBM, IMG, BNP, PNG, MNG, JNG, PICT, DWG, TIFF, JPEG, JPEG2000, DICOM, MPEG, MPEG-1, MPEG-2, MPEG-4, AVI, D1, D2, D3, D4, D5, D6, D7, D9, DV, DVCam, DVCPRO, DCT, Digital8, D-VHS, W-VHS, Digital S, HDD-1000, HD, DivX, XviD, QuickTime, Flash, WMV9, WMA, RealVideo, RealMedia, MOV, SWF, and/or DIF, etc. A digital image product can be comprised by and/or can comprise one or more web sites, web pages, libraries, albums, images, etc.
digital image product quality variable—a variable of a digital image product related to a humanly perceivable quality, such as resolution, bit rate, color fidelity, noise, etc.
display—(v.) to visually render and/or make perceptible. (n.) an electronic device that represents information in visual form and/or a visual representation of something.
down-sampling—reducing the resolution, quality, and/or bit rate of a digital image product by utilizing only a portion of its content without substantially cropping that content. Methods for down-sampling a digital photo can include a bicubic interpolation technique. Methods for down-sampling a digital video can include compression, spatial down-sampling, temporal down-sampling, horizontal down-sampling, vertical down-sampling, etc.
encoding—the process of transforming a linear digital information stream into another digital data stream, such as for the purpose of maximizing information content as desired for a particular application, while minimizing the information rate (bandwidth) (e.g., G.711, G.722, G.728, etc).
from—used to indicate a source.
further—in addition.
hierarchical—organized, segregated, and/or classified according to various criteria into successive levels and/or layers.
image—an at least two-dimensional representation, reproduction, and/or picture of an entity and/or phenomenon; and/or a point mapping of luminous points of an object located in one region of space to points in another region of space, formed by refraction or reflection of light in a manner which causes light from each point of the object to converge to or diverge from a point somewhere else (on the image).
incrementing—changing a value to point to a next logical record of a plurality of records.
information—facts, terms, concepts, phrases, expressions, commands, numbers, characters, and/or symbols, etc., that are related to a subject. Sometimes used synonymously with data, and sometimes used to describe organized, transformed, and/or processed data. It is generally possible to automate certain activities involving the management, organization, storage, transformation, communication, and/or presentation of information.
information device—any device on which resides a finite state machine capable of implementing at least a portion of a method, structure, and/or or graphical user interface described herein. An information device can comprise well-known communicatively coupled components, such as one or more network interfaces, one or more processors, one or more memories containing instructions, one or more input/output (I/O) devices, and/or one or more user interfaces (e.g., coupled to an I/O device) via which information can be rendered to implement one or more functions described herein. For example, an information device can be any general purpose and/or special purpose computer, such as a personal computer, video game system (e.g., PlayStation, Nintendo Gameboy, X-Box, etc.), workstation, server, minicomputer, mainframe, supercomputer, computer terminal, laptop, wearable computer, and/or Personal Digital Assistant (PDA), ipod, mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, a digital signal processor, an ASIC or other integrated circuit, a hardware electronic logic circuit such as a discrete element circuit, and/or a programmable logic device such as a PLD, PLA, FPGA, or PAL, or the like, etc.
interfere—to obstruct and/or impede.
less than—having a measurably smaller magnitude and/or degree as compared to something else.
machine—a device and/or assembly adapted to perform at least one task.
machine instructions—directions adapted to cause a machine, such as an information device, to perform one or more particular activities, operations, and/or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can obtain and/or store data, information, and/or instructions. Examples include memories, punch cards, and/or optically-readable forms, etc.
metadata—data about data. In the context of a digital photo, the data is the information content of the digital photo and the metadata is information regarding the content and/or the electronic file, such as the time (date, hour, minute, and/or second, etc.) the photo was taken, the camera with which the photo was taken, the time the photo was transferred from the camera, whether the photo is in color or black and white, the name and/or location of an album, collection, and/or website associated with the photo, keywords, tags, and/or comments about the photo, such as the photographer, the location at which the photo was taken, who and/or what appear in the photo, and/or the nature of the event photographed, etc., and/or information regarding the electronic file itself, such as the electronic file name, size, storage location, path, modification time, modification author, the file icon, ownership, and/or access, control, modification, publication, distribution, and/or public performance rights, privileges, attributions, and/or protections, etc. In the context of a digital video, the data is the information content of the digital video and the metadata is information regarding the content and/or the electronic file, such as the time (date, hour, minute, and/or second, etc.) the video was taken, the camera with which the video was taken, the time the video was transferred from the camera, the name and/or location of an album, collection, and/or website associated with the video; the resolution, bit rate, quality, color fidelity, format, compression algorithm, and/or protocol of the video; keywords, tags, and/or comments about the video, such as the videographer, the date and/or location at which the video was taken, who and/or what appear in the video, and/or the nature of the event videographed, etc.; and/or information regarding the electronic file itself, such as the electronic file name, size, storage location, path, modification time, modification author, the file icon, ownership, and/or access, control, modification, publication, distribution, and/or public performance rights, privileges, attributions, and/or protections, etc.
method—a process, procedure, and/or collection of related activities for accomplishing something.
not—a negation of something.
notification—information transmitted to advise an entity of an event, status, and/or condition.
number—a count and/or quantity.
photograph—an image created by collecting and focusing reflected electromagnetic radiation. The most common photographs are those created of reflected visible wavelengths, producing permanent records of what the human eye can see.
predetermined—established in advance.
preview—to preliminarily and/or introductorily exhibit, render, view, and/or perceive.
previously—earlier.
processor—a hardware, firmware, and/or software machine and/or virtual machine comprising a set of machine-readable instructions adaptable to perform a specific task. A processor can utilize mechanical, pneumatic, hydraulic, electrical, magnetic, optical, informational, chemical, and/or biological principles, mechanisms, signals, and/or inputs to perform the task(s). In certain embodiments, a processor can act upon information by manipulating, analyzing, modifying, and/or converting it, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such as the Pentium IV series of microprocessors manufactured by the Intel Corporation of Santa Clara, Calif. In certain embodiments, the processor can comprise and/or be comprised by a dedicated purpose and/or user-configurable device, such as an Application Specific Integrated Circuit (ASIC), Application Specific Standard Product (ASSP), Programmable Logic Device (PLD), Field Programmable Gate Array (FPGA), Programmable Array Logic (PAL), and/or Complex Programmable Logic Device (CPLD) that has been designed to implement in its hardware and/or firmware at least a part of an embodiment disclosed herein. A processor can reside on and use the capabilities of a controller.
product—something produced by human effort.
production—creation.
quality—a characteristic, attribute, trait, and/or property.
receipt—a completion of an act of receiving.
receive—to gather, take, acquire, obtain, accept, get, and/or have bestowed upon.
related—connected to and/or associated with.
render—to make humanly perceptible.
request—(v.) to express a need and/or desire for; to inquire and/or ask for. (n.) that which communicates an expression of desire and/or that which is asked for.
result—an outcome and/or consequence of a particular action, operation, and/or course.
said—when used in a system or device claim, an article indicating a subsequent claim term that has been previously introduced.
synchronize—to cause to match exactly.
server—an information device and/or a process running thereon that is adapted to be communicatively coupled to a network and that is adapted to provide at least one service for at least one other information device communicatively coupled to the network and/or for at least one process running on the other information device. A common example is a file server, which has a local disk and services requests from remote clients to read and write files on that disk. A server can also provide access to resources, such as programs, shared devices, etc.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
store—to place, hold, retain, enter, and/or copy into and/or onto a machine-readable medium.
sufficient—to a degree necessary to achieve a predetermined result.
suitable—appropriate for a specified condition, purpose, and/or occasion.
system—a collection of mechanisms, devices, data, and/or instructions, the collection designed to perform one or more specific functions.
transform—to modify.
transformation—a modification and/or result of transforming, such as a modification of data and/or metadata.
transmit—to provide, furnish, supply, send as a signal, and/or to convey (e.g., force, energy, and/or information) from one place and/or thing to another.
unreceived—not received.
uploaded—transferred from a first information device to a second information device.
uploading—transferring from a first information and/or memory device to a second information and/or memory device, typically from a client to a server.
user—a person, organization, process, device, program, protocol, and/or system that uses a device, system, process, and/or service.
value—a measured, assigned, determined, and/or calculated quantity or quality for a variable and/or parameter.
variable—(n) a property, parameter, and/or characteristic capable of assuming any of an associated set of values. (adj) likely to change and/or vary; subject to variation; and/or changeable.
version—a particular form and/or variation of an identified item.
via—by way of and/or utilizing.
video—a collection of framed images presented sequentially to simulate motion and interactivity.
website—an entire collection of web pages and/or other information (such as images, sound, and/or video files, etc.) that are made available through what appears to users as a single web server.
web-viewing—to view an image in its entirety via a browser rendered on a display device.
wherein—in regard to which; and; and/or in addition to.
while—during some portion of the time that.
without—not accompanied by.

What is claimed is:

1. A method comprising:
applying, via a first client information device, a user-requested transformation to a predetermined version of a digital image product while a first version of said digital image product is automatically uploaded from said first client information device to a predetermined server and without interfering with said applying said user-requested transformation, said first version automatically uploaded after a second version of said digital image product is automatically uploaded from said first client information device to said predetermined server, said second version automatically created by down-sampling said first version, said first version characterized by a first value of a digital image product quality variable, said second version characterized by a predetermined second value of said digital image product quality variable that is less than said first value.

2. The method of claim 1, further comprising:
receiving said first version from a digital image production device communicatively coupled to said first client information device.

3. The method of claim 1, further comprising:
receiving said first version from a digital camera communicatively coupled to said first client information device.

4. The method of claim 1, further comprising:
receiving said first version from a digital video camera communicatively coupled to said first client information device.

5. The method of claim 1, further comprising:
on said first client information device, automatically down-sampling said first version of said digital image product to said second version of said digital image product.

6. The method of claim 1, further comprising:
before said second version is automatically uploaded, automatically displaying said second version via said first client information device.

7. The method of claim 1, further comprising:
before said first version is automatically uploaded, automatically displaying said second version via said first client information device.

8. The method of claim 1, further comprising:
automatically uploading said second version from said first client information device to said predetermined server.

9. The method of claim 1, further comprising:
automatically uploading said first version from said first client information device to said predetermined server.

10. The method of claim 1, further comprising:
after automatically uploading said second version from said first client information device to said predetermined server, automatically uploading said first version from said first client information device to said predetermined server.

11. The method of claim 1, further comprising:
receiving, from a user, said user-requested transformation while said first version is automatically uploaded.

12. The method of claim 1, further comprising:
automatically storing, on said first client information device, information sufficient to cause said user-requested transformation.

13. The method of claim 1, further comprising:
automatically transmitting, from said first client information device to said predetermined server, information sufficient to cause said user-requested transformation to be applied via said predetermined server to said first version without said predetermined server receiving a transformed version of said digital image product resulting from application of said user-requested transformation at said first client information device.

14. The method of claim 1, further comprising:
automatically requesting, from said predetermined server, a hierarchical version number associated with a predetermined version of said digital image product.

15. The method of claim 1, further comprising:
automatically receiving, from said predetermined server, a hierarchical version number associated with a predetermined version of said digital image product.

16. The method of claim 1, further comprising:
automatically requesting, from said predetermined server, information sufficient to determine whether said first version is current.

17. The method of claim 1, further comprising:
automatically receiving, from said predetermined server, information sufficient to determine whether said first version is current.

18. The method of claim 1, further comprising:
automatically receiving, from said predetermined server, a predetermined version of said digital image product.

19. The method of claim 1, further comprising:
automatically receiving, from said predetermined server, a current version of said digital image product.

20. The method of claim 1, wherein:
said digital image product is a digital photograph.

21. The method of claim 1, wherein:
said digital image product is a digital video.

22. The method of claim 1, wherein:
said second version is suitable for previewing.

23. The method of claim 1, wherein:
said second version is suitable for web-viewing.

24. The method of claim 1, wherein:
said transformation is related to data of said digital image product.

25. The method of claim 1, wherein:
said transformation is related to metadata of said digital image product.

26. A system comprising:
an image product processor adapted to apply, via a first client information device, a user-requested transformation to a predetermined version of a digital image product while a first version of said digital image product is automatically uploaded from said first client information device to a predetermined server and without interfering with said applying said user-requested transformation, said first version automatically uploaded after a second version of said digital image product is automatically uploaded from said first client information device to said predetermined server, said second version automatically created by down-sampling said first version, said first version characterized by a first value of a digital image product quality variable, said second version characterized by a predetermined second value of said digital image product quality variable that is less than said first value.

27. A machine-readable medium comprising machine instructions for activities comprising:
applying, via a first client information device, a user-requested transformation to a predetermined version of a digital image product while a first version of said digital image product is automatically uploaded from said first client information device to a predetermined server and without interfering with said applying said user-requested transformation, said first version automatically uploaded after a second version of said digital image product is automatically uploaded from said first client information device to said predetermined server, said second version automatically created by down-sampling said first version, said first version characterized by a first value of a digital image product quality variable, said second version characterized by a predetermined second value of said digital image product quality variable that is less than said first value.

28. A signal comprising machine instructions for activities comprising:
applying, via a first client information device, a user-requested transformation to a predetermined version of a digital image product while a first version of said digital image product is automatically uploaded from said first client information device to a predetermined server and without interfering with said applying said user-requested transformation, said first version automatically uploaded after a second version of said digital image product is automatically uploaded from said first client information device to said predetermined server, said second version automatically created by down-sampling said first version, said first version characterized by a first value of a digital image product quality variable, said second version characterized by a predetermined second value of said digital image product quality variable that is less than said first value.

29. A method comprising:
automatically applying, at a predetermined server, a transformation to a first version of a digital image product, said transformation previously applied at a first client information device while a first version of said digital image product was automatically uploading from said first client information device to said predetermined server without interfering with applying said transformation at said first client information device, said first version automatically received from said first client information device at said predetermined server after a second version of said digital image product was automatically received from said first client information device at said predetermined server, said second version a down-sampled version of said first version, said first version characterized by a first value of a digital image product quality variable, said second version characterized by a predetermined second value of said digital image product quality variable that is less than said first value, said predetermined server not storing a transformed version of said digital image product resulting from application of said transformation at said first client information device.

30. The method of claim 29, further comprising:
automatically receiving said first version of said digital image product from said first client information device.

31. The method of claim 29, further comprising:
automatically receiving said second version of said digital image product from said first client information device.

32. The method of claim 29, further comprising:
automatically receiving said first version of said digital image product from said first client information device after a second version of said digital image product has been automatically received from said first client information device at said predetermined server.

33. The method of claim 29, further comprising:
automatically assigning a hierarchical version number to said digital image product.

34. The method of claim 29, further comprising:
automatically assigning a hierarchical version number to a collection that comprises said digital image product.

35. The method of claim 29, further comprising:
automatically assigning a hierarchical version number to a website that comprises said digital image product.

36. The method of claim 29, further comprising:
automatically incrementing a hierarchical version number of said digital image product upon receipt by said predetermined server of a previously un-received version of said digital image product.

37. The method of claim 29, further comprising:
automatically receiving, from said first client information device, information sufficient to determine that said first client information device stores a current version of said digital image product.

38. The method of claim 29, further comprising:
automatically transmitting, from said predetermined server, a notification that said first client information device does not store a current version of said digital image product.

39. The method of claim 29, further comprising:
automatically receiving, from said first client information device at said predetermined server, a signal encoding information sufficient to apply, via said predetermined server, said transformation to said first version of said digital image product.

40. The method of claim 29, further comprising:
automatically transmitting, to said first client information device, a third version of said digital image product, said third version resulting from said automatically applying, at said predetermined server, said transformation to said first version.

41. The method of claim 29, further comprising:
automatically transmitting, to a second client information device, a third version of said digital image product, said third version resulting from said automatically applying, at said predetermined server, said transformation to said first version.

42. The method of claim 29, further comprising:
automatically applying, via said predetermined server, said transformation to said second version of said digital image product.

43. The method of claim 29, further comprising:
automatically creating, via said predetermined server, a fourth version of said digital image product, said fourth version a down-sampled version of a third version of said digital image product, said third version resulting from applying said transformation to said first version.

44. The method of claim 29, wherein:
said digital image product is a digital photograph.

45. The method of claim 29, wherein:
said digital image product is a digital video.

46. The method of claim 29, wherein:
said transformation is related to data of said digital image product.

47. The method of claim 29, wherein:
said transformation is related to metadata of said digital image product.

48. A system comprising:
an image product processor adapted to automatically apply, at a predetermined server, a transformation to a first version of a digital image product, said transformation previously applied at a first client information device while a first version of said digital image product was automatically uploading from said first client information device to said predetermined server without interfering with applying said transformation at said first client information device, said first version automatically received from said first client information device at said predetermined server after a second version of said digital image product was automatically received from said first client information device at said predetermined server, said second version a down-sampled version of said first version, said first version characterized by a first value of a digital image product quality variable, said second version characterized by a predetermined second value of said digital image product quality variable that is less than said first value, said predetermined server not storing a transformed version of said digital image product resulting from application of said transformation at said first client information device.

49. A machine-readable medium comprising machine instructions for activities comprising:
applying, at a predetermined server, a transformation to a first version of a digital image product, said transformation previously applied at a first client information device while a first version of said digital image product was automatically uploading from said first client information device to said predetermined server without interfering with applying said transformation at said first client information device, said first version automatically received from said first client information device at said predetermined server after a second version of said digital image product was automatically received from said first client information device at said predetermined server, said second version a down-sampled version of said first version, said first version characterized by a first value of a digital image product quality variable, said second version characterized by a predetermined second value of said digital image product quality variable that is less than said first value, said predetermined server not storing a transformed version of said digital image product resulting from application of said transformation at said first client information device.

50. A signal comprising machine instructions for activities comprising:
applying, at a predetermined server, a transformation to a first version of a digital image product, said transformation previously applied at a first client information device while a first version of said digital image product was automatically uploading from said first client information device to said predetermined server without interfering with applying said transformation at said first client information device, said first version automatically received from said first client information device at said predetermined server after a second version of said digital image product was automatically received from said first client information device at said predetermined server, said second version a down-sampled version of said first version, said first version characterized by a first value of a digital image product quality variable, said second version characterized by a predetermined second value of said digital image product quality variable that is less than said first value, said predetermined server not storing a transformed version of said digital image product resulting from application of said transformation at said first client information device.
